(19) United States
(12) Patent Application Publication
(10) Pub. No.: US 2010/0139690 A1
(43) Pub. Date: Jun. 10, 2010

(54) CLEANING APPLIANCE COMPRISING A MICROWAVE DRYING SYSTEM

(76) Inventors: Bruno Gaus, Offenburg (DE); Thomas Naeger, Offenburg (DE); Thomas Peukert, Buehl (DE); Stefan Scheringer, Offenburg (DE); Ingo Wiegand, Buehlertal (DE)

Correspondence Address: Muncy, Geissler, Olds & Lowe, PLLC, 4000 Legato Road, Suite 310, FAIRFAX, VA, 22033, US

(21) Appl. No.: 12/627,979

(22) Filed: Nov. 30, 2009

Related U.S. Application Data
(63) Continuation of application No. PCT/EP2008/002263, filed on Mar. 20, 2008.

(30) Foreign Application Priority Data
May 30, 2007 (DE) DE102007025 262.7

(51) Int. Cl. B08B 3/00

(52) U.S. Cl. 134/1; 134/115 R

(57) ABSTRACT

A cleaning appliance is provided for cleaning objects to be cleaned. The cleaning appliance comprises at least one cleaning zone for cleaning the object to be cleaned using a cleaning liquid. The cleaning appliance further comprising a microwave drying device which can be used for at least partially drying the object to be cleaned.

This nonprovisional application is a continuation of International Application No. PCT/EP2008/002263, which was filed on Mar. 20, 2008, and which claims priority to German Patent Application No. DE 10 2007 025 262.7, which was filed in Germany on May 30, 2007, and which are both herein incorporated by reference.

### BACKGROUND OF THE INVENTION

1. Field of the Invention

The invention relates to a cleaning appliance for cleaning objects to be cleaned in a cleaning zone. Cleaning appliances of this type are used for example in the form of continuous-flow dishwashing machines or single-chamber dishwashing machines in rinsing technology or in the form of commode rinsers for cleaning objects to be cleaned having comparatively high liquid waste in the field of nursing homes, elderly care homes or hospitals.

2. Description of the Background Art

A large number of different variations of cleaning appliances for cleaning objects to be cleaned or objects to be rinsed are known in the art. The configuration of these cleaning appliances depends on various boundary conditions such as the nature of the rinsing objects to be cleaned, the spoiling, the throughput or similar conditions.

The invention described hereinafter is applicable to numerous cleaning appliances for cleaning a broad range of types of objects to be cleaned. A first particular focus resides in the field of dishwashing machines. Dishwashing machines of this type are known as domestic appliances and also as industrial dishwashing machines for use, for example, in staff canteens, hospitals, schools, authority canteens or similar institutions having large kitchens. Industrial dishwashing machines are divided into continuous-flow dishwashing machines in which the cleaning object to be rinsed (for example cups, plates, cutlery, glasses, trays or similar objects to be rinsed) successively passes through a plurality of cleaning zones. For example, a continuous-flow dishwashing machine of this type can have a pre-clearing zone, a washing zone, a clear-rinsing zone and a drying zone. Dishwashing machines having fewer cleaning zones are also known. Continuous-flow dishwashing machines are configured in the prior art, for example, as belt transportation or basket transportation machines.

Single-chamber dishwashing machines, on the other hand, conventionally have a single rinsing chamber as the cleaning zone in which, again, objects to be cleaned, for example in the form of cups, plates, glasses, cutlery, crockery or trays, can be cleaned. Conventionally, single-chamber dishwashing machines are operated for the domestic field in water change, i.e. one and the same tank is conventionally used for a rinsing program and an after-rinsing step, the water or the cleaning liquid being exchanged in the tank between these steps. In order to increase the throughput, use is made, for industrial application, of single-chamber dishwashing machines having, in addition to a washing tank, an after-rinsing tank, for example a boiler. In this after-rinsing tank, after-rinsing liquid (for example water with a clear-rinsing additive) can be heated to an after-rinsing temperature, while the actual washing process proceeds in the rinsing chamber.

A further focus of the present application is on cleaning appliances which are suitable for the cleaning of medical equipment and/or care equipment. In particular, this may be objects to be cleaned in which there accumulate large amounts of liquid waste and/or solid waste which must be disposed of. Examples of this include chamber pots, commodes, bedpans, urine bottles or similar vessels in which amounts of liquid of more than a few 10 ml up to the liter range may easily accumulate. Cleaning appliances of this type will be designated hereinafter as “commode rinsers” without restricting the object to be cleaned to a specific care appliance.

Both in dishwashing machines and especially in commode rinsers, as well as in other types of cleaning appliances, a hygienic effect of the cleaning may in many cases be particularly important. Thus, in the case of dishwashing machines, it is necessary to ensure that clinging dirt is safely removed from all of the types of objects to be cleaned or rinsed which may enter directly or indirectly into contact with food or beverages. More extensive problems arise in commode rinsers in which clinging germs (viruses or bacteria) can harbor an increased risk of infection. In many cases, it is therefore necessary to sanitize the object to be cleaned. This sanitation may range from a simple prevention of germs by way of disinfection (for example disinfection using chemical disinfectants and/or thermal disinfection using water vapor or a different type of heat action) up to complete sterilization of the object to be cleaned.

During cleaning and if appropriate sanitization, it has for various reasons often proven important to ensure sufficient drying of the object to be cleaned. Drying of the object to be cleaned is essential also for subsequent handling of the object to be cleaned, for example removal by operators and subsequent reuse. Thus, in continuous-flow dishwashing machines, one or more cleaning zones are for example in many cases adjoined by one or more drying zones in which the object to be rinsed is acted on with heat in the form of hot air. Accordingly, a drying step with a heat treatment is generally also carried out in single-chamber dishwashing machines. Drying is in many cases also indispensable in commode rinsers, as moisture remaining on the object to be cleaned can easily lead to recontamination of the object to be cleaned.

However, the drying of the object to be cleaned, in particular thermal drying, is a major challenge in terms of design. For example, the amount of energy consumed by hot air blowers for drying in continuous-flow dishwashing machines is in many cases several kilowatts, for example 6 kW; this may constitute one quarter or more as a proportion of the total amount of energy consumed by the dishwashing machine. Similar problems arise in other types of dishwashing machines or commode rinsers. The requirements of the drying cause in many cases greatly increased consumption of energy, a large part of this energy often escaping unused from the cleaning appliances.

### SUMMARY OF THE INVENTION

It is therefore an object of the present invention to provide a cleaning appliance which at least substantially avoids the above-described drawbacks of known cleaning appliances. In particular, it is an object of the present invention to provide a cleaning appliance which ensures energy-efficient and safe cleaning of the object to be cleaned.

This object is achieved by the invention having the features of the independent claim. Advantageous developments of the invention are characterized in the sub-claims. The wording of all of the claims is hereby made part of the content of this description by way of reference.

The invention proposes a cleaning appliance for cleaning objects to be cleaned that has at least one cleaning zone for cleaning the object to be cleaned using a cleaning liquid. For example, the cleaning appliance may correspond to a known cleaning appliance according to the foregoing description of the prior art and can comprise, for example, a continuous-flow dishwashing machine, a single-chamber dishwashing machine (in particular for industrial use) and/or a commode rinser.

A basic idea of the present invention consists in bypassing or in avoiding the problems of the previously known drying devices of conventional cleaning appliances by transferring the principle of microwave drying to the described cleaning appliances. The principle of microwave drying is known from various other fields of technology, for example the building trade, where microwave drying is used, for example, for drying damp masonry. Other areas of use include for example the production of paint and coating technology, in which microwave methods are used for drying the coatings, see for example EP 1327844 A2, which is incorporated herein by reference.

It is accordingly proposed to equip the cleaning appliance with a corresponding microwave drying device for at least partially drying the object to be cleaned. This microwave drying device can comprise for example one or more microwave sources. As an example, a microwave source of this type can have a magnetron. However, other types of microwave sources, which may be used alternatively or additionally, are also known.

In addition to the microwave source, the microwave drying device can further comprise at least one waveguide. This waveguide can in particular be used to guide the microwaves from the microwave source to a housing, for example an interior of the cleaning zone (for example an interior of a rinsing chamber). In particular, the at least one waveguide can also be used to orient the microwaves onto the object to be cleaned, for example in that this waveguide has an opening which is oriented accordingly onto the object to be cleaned. An opening of the waveguide inside the cleaning zone can have a closable opening, for example an opening flap. In particular, this opening flap may be configured in such a way as to prevent cleaning liquid from infiltrating the waveguide and/or the microwave source. For example, the opening flap provided may be a spring-mounted opening flap which is automatically opened by a blower of the microwave drying device. A valve which can be opened automatically (for example electromechanically) may also be provided at the opening.

The microwave drying device can furthermore be configured to apply hot air to the object to be cleaned. For example, the above-described waveguide can be used to guide hot air to the object to be cleaned. It is in this case particularly preferable for the microwave drying device to have a blower which is used for generating the hot air. A microwave source can itself be used for this generating of hot air, as the microwave source generally produces waste heat. For example, use may be made of a cooling blower of the microwave drying device that first guides air to the microwave source, the air being heated there, in order subsequently to apply this air to the object to be rinsed or object to be cleaned. In this way, the microwave drying effect is additionally supported by heated ambient air or heated clean air, without the need for a separate blower with a device for heating the air. A large amount of energy may be saved in this way.

Within the scope of the present application, the term “microwaves” refers in this case to frequencies of between 0.3 and 300 GHz. Such frequencies may be applied to the object to be cleaned in continuous wave mode or in pulsed mode. In this case, the microwave drying device may be configured to act on the object to be cleaned with microwaves having a frequency or within an individual frequency band, or the microwave drying device may be configured to act on the object to be cleaned with microwaves having at least two frequencies. It is in this case particularly advantageous if the microwave radiation is selected in such a way as not to be absorbed or to be absorbed only slightly by the materials of the cleaning appliance, for example by the chamber walls of a cleaning zone and/or rinsing chamber. Nowadays, this is easily possible with modern microwave sources, for example the above-described magnetron. In addition, cleaning appliances may also be configured accordingly using suitable materials which are for example transparent (i.e. non-absorbent or only slightly absorbent) to the microwave radiation used, i.e. do not heat up significantly.

In this way, it is possible to manufacture, by means of the microwave drying, a cleaning appliance, the drying of which proceeds much more rapidly than in conventional cleaning appliances and which is much more favorable than known cleaning appliances in terms of the amount of energy consumed.

As the object to be rinsed conventionally has just small surfaces, the drying energy can be applied, by way of the microwave irradiation, in a more targeted manner to the surfaces to be dried, allowing the energy efficiency to be greatly improved over the conventional blower methods.

The microwave drying device may in particular be configured to emit microwaves having at least one frequency or in a frequency band which is wholly or partially absorbed by the cleaning liquid clinging to the object to be cleaned. If, for example, use is made of a cleaning liquid containing water, use may be made of the frequencies of approx. 2.5 GHz which are conventionally used for water. However, other frequencies are also possible, for example frequencies in the range of approx. 850 MHz or 3.87 GHz. Frequency modulations are also possible, such as is described for example in EP 1327844 A2.

Alternatively or additionally to the irradiation of microwave radiation which is absorbed by the cleaning liquid, it is also possible to use microwave radiation having a frequency band or a frequency which is at least partially absorbed by the object itself to be cleaned. For example, it is possible to influence ceramics or porcelain in a targeted manner using microwave radiation. In this way, the object to be cleaned can be heated in a targeted manner, so that the clinging cleaning liquid evaporates. For example, the type of the object to be cleaned can be set by a user, for example by selection from a list of possible types of object to be cleaned. As the types of the object to be cleaned are conventionally restricted, in particular in industrial use, to a few types, it is easily possible to draw up such a list. Thus, for example, a user can select in a program-controlled manner from a list one or more types of object to be cleaned, after which one or more corresponding microwave frequency bands are then selected, preferably automatically (for example by a controller, in particular a computer), and the microwave drying is carried out at this frequency or these frequencies.

Furthermore, use may also be made of microwave radiation which is concentrated in a frequency band, preferably a narrow frequency band. Preferably, the microwave drying device or the cleaning appliance is in this case configured in such a way as to allow the frequency band to be varied over time. In this manner, the frequency band can for example be tuned in such a way that the frequency band covers successively different frequency ranges. In this way, it is possible to attain a narrow active band which is time-delayed. This provides higher energy density than in broadband irradiation; this can cause more efficient drying.

In order to control the microwave irradiation, the cleaning appliance can further have at least one temperature sensor for detecting the temperature of the object to be rinsed. This at least one temperature sensor can be connected for example to an open or closed-loop control apparatus (for example a central controller of the cleaning appliance) which controls the microwave drying device accordingly. In this way, it is possible to maximize the efficiency of the drying and/or prevent overheating of the cleaning appliance. The at least one temperature sensor can for example comprise a temperature sensor attached to the cleaning appliance. Alternatively or additionally, the temperature sensor can also have an infrared sensor which can detect by way of infrared radiation a temperature (for example within a temperature range between 0° C. and 250° C.) of the object to be rinsed. However, other types of temperature sensors are also possible.

As described above, the cleaning appliance may in particular comprise a continuous-flow dishwashing machine or be a continuous-flow dishwashing machine. In this case, the cleaning zone is preferably configured in such a way as to comprise at least one clear-rinsing zone. In this case, the microwave drying device is preferably arranged after the clear-rinsing zone in a direction of continuous flow. This ensures that the drying follows (preferably immediately) the clear-rinsing process in the clear-rinsing zone. For example, a drying zone, in which the microwave drying device is arranged, can adjoin the clear-rinsing zone.

Furthermore, it is, as described above, preferable if the microwave drying device comprises at least one blower which is used for assisting the microwave drying. For example, this may, as described above, be a blower which cools a magnetron, after which the cooling air flow is subsequently directed onto the object to be cleaned. For example, the microwave drying device may be configured to generate, by means of the blower, an air flow which is directed substantially perpendicularly to a direction of continuous flow of the dishwashing machine.

This idea of generating an air flow through the microwave drying device may in particular be extended as a result of the fact that the dishwashing machine further comprises at least one heat recovery device. This heat recovery device may in particular be configured to recover at least a part of the heat contained in the air flow. This heat can subsequently be returned to the continuous-flow dishwashing machine. This recycling of heat can for example be carried out in that the heat recovery device comprises one or more heat exchangers, heat exchanger liquid from this heat exchanger subsequently being returned to a tank (for example a washing tank or an after-rinsing tank) of the continuous-flow dishwashing machine. In this way, heating power may be saved in this tank.

Alternatively or additionally, the continuous-flow dishwashing machine can also have at least one steam precipitation device. This steam precipitation device can be used to completely or partially recover moisture contained in the air flow generated by the blower after drying or contacting of the object to be cleaned. This moisture can for example be condensed, wherein the condensate, which still has an elevated temperature, can for example be returned to a tank of the dishwashing machine in order to subsequently (for example after slight further heating) be reused for cleaning or after-rinsing. In this way, the energy efficiency of the continuous-flow dishwashing machine may be greatly increased. The steam precipitation device can comprise for example one or more cooling surfaces and/or metal cooling sheets on which condensation can occur. The cooling surfaces may be configured purely passively or may also be cooled actively by a cooling liquid. In this way, it is for example also possible to combine the idea of the heat recovery device with the idea of the steam precipitation device, as a heat exchanger can be used in both cases.

Alternatively or additionally to the continuous-flow dishwashing machine, the cleaning appliance may, as described above, also comprise or be a single-chamber dishwashing machine. In particular, this single-chamber dishwashing machine may also be an industrial single-chamber dishwashing machine, a single-chamber dishwashing machine which preferably has, in addition to a washing tank, a separate, in particular a separately heatable, after-rinsing tank, preferably a boiler. The cleaning zone of the cleaning appliance can accordingly comprise a rinsing chamber of the single-chamber dishwashing machine.

In particular, the single-chamber dishwashing machine may be configured to carry out a cleaning program. It is in this case particularly preferable if the cleaning program has at least one cleaning program step, the object to be cleaned being cleaned using the cleaning liquid in the at least one cleaning program step. For example, the cleaning liquid used may, again (as is also possible in the other cleaning appliances), be a cleaning liquid comprising water. In addition, additives may be provided, such as rinsing agents or other cleaning liquids. Furthermore, an after-rinsing step, in which the object to be cleaned is after-rinsed using an after-rinsing liquid (for example water or water with a clear-rinser), may also be provided. Preferably, the cleaning program further has a drying step which follows the cleaning program step in time and in which the object to be cleaned is at least partially dried using the microwave drying device.

In the case of the single-chamber dishwashing machine too, it has proven advantageous to provide a blower of the microwave drying device that assists the drying. In this embodiment of the invention, it has in turn proven to be particularly advantageous if the microwave drying device is configured to generate, by means of the blower, a substantially upwardly directed air flow. This air flow can act on or flow around the object to be cleaned, which is received in the rinsing chamber, and in this way absorb moisture.

In this exemplary embodiment, in which an air flow of the microwave drying device is used for assisting the drying, it has proven advantageous if the single-chamber dishwashing machine has at least one hot air outlet for discharging the air flow from the rinsing chamber. This hot air outlet may be configured for example as a simple opening, for example an opening in the upper region (for example in the cover region and/or in the walls region close to a rinsing chamber cover). However, alternatively or additionally, the hot air outlet can also merge with a run-out of the dishwashing machine. This prevents humid air from leaving the rinsing chamber and entering the environment and impairing the working conditions of the operators there. This development of the invention is advantageously apparent, in particular in large kitchens. In order to avoid the formation of odors, it has in this case proven advantageous if the run-out has at least one siphon bend in which a water supply can be received as an odor trap. The hot air outlet can then merge with the run-out while bypassing this siphon bend or the water supply in this siphon bend. As an odor trap, i.e. in order to prevent contaminated air from passing from the run-out into the interior of the rinsing chamber through the hot air outlet, the hot air outlet can be equipped with a corresponding valve, for example a self-locking valve, for example a check valve.

Alternatively or additionally, in the continuous-flow dishwashing machine, the hot air outlet can further have, as in the foregoing description, at least one heat recovery device. For example, this heat recovery device can, again, comprise a heat exchanger, wherein the above-described ideas can be applied in a similar manner. Thus, in particular, heat exchanger liquid can, again, be returned to a tank of the single-chamber dishwashing machine, so that discharged drying heat can be wholly or partially utilized for heating the cleaning liquid (rinsing liquid and/or after-rinsing liquid). Alternatively or additionally to the heat recovery device, the single-chamber dishwashing machine can, again, also have a steam precipitation device. In the case of the single-chamber dishwashing machine, as also in the continuous-flow dishwashing machine, this steam precipitation device can also comprise one or more cooling surfaces on which humid air wholly or partially condenses, wherein preferably the condensate may, again, subsequently be used, owing to its elevated temperature, for cleaning (rinsing and/or after-rinsing) the object to be cleaned.

Alternatively or additionally to a continuous-flow dishwashing machine and/or a single-chamber dishwashing machine, the cleaning appliance may, as described hereinbefore, also comprise a commode rinser according to the definition described at the outset or be a commode rinser of this type. In this case, it should in particular be possible to use the commode rinser for cleaning objects to be cleaned in which relatively large amounts of liquid waste and/or solid waste, for example several 10 ml up to a few liters of liquid waste, can accumulate. Thus, the commode rinser is configured for cleaning medical equipment or caring equipment. For example, the commode rinser may be configured as described in DE 10348344 A1, which corresponds to U.S. Publication No. 20070104608, and which is incorporated herein by reference.

The cleaning zone of the commode rinser comprises a rinsing chamber. The commode rinser is to be configured to act on objects to be cleaned in this rinsing chamber with the cleaning liquid. In addition, further cleaning processes may proceed in the rinsing chamber, for example automatic emptying of the object to be rinsed preceding the cleaning. For this purpose, the commode rinser can for example, again, have a run-out into which the object to be cleaned can be emptied. Again, this may in this case be a run-out with a siphon bend which can receive a water supply acting as an odor trap.

Furthermore, a microwave drying device, which is configured to at least partially dry the object to be cleaned in the rinsing chamber, is provided, as described above. Thus, the cleaning appliance or commode rinser may be configured to carry out a cleaning program. At least one cleaning program step, in which the object to be cleaned is cleaned using the cleaning liquid, may be provided in this cleaning program. The cleaning program can further have at least one drying step which follows the cleaning program step in time and in which the object to be cleaned is at least partially dried using the microwave drying device. A central controller, which controls the operation of the cleaning appliance, may in particular be provided, as also in the case of the single-chamber dishwashing machine and/or in the case of the continuous-flow dishwashing machine. In the case of the commode rinser and/or the single-chamber dishwashing machine, the sequence of the activation of the microwave drying device in time may, for example, be taken over by this controller. However, other types of control are also possible. In particular, the microwave power, a pulse duration and/or a continuous operation, a frequency band or similar parameters of the microwave drying device can also be activated. In particular, the controller may be configured in such a way that the microwave drying device or the microwave source is not switched on until the drying step.

Furthermore, the commode rinser can comprise a steam generating device. This steam generating device may for example likewise, again, be configured as described in DE 10348344 A1. The commode rinser may in this case be configured to sanitize the object to be cleaned by means of steam. The term “sanitizing” refers in this case to a specific or non-specific reduction of germs. This reduction of germs may range up to disinfection or, depending on the steam conditions, even up to almost complete sterilization. In this case, the cleaning program may for example be configured in such a way that at least one sanitizing step, in which the object to be cleaned is acted on with steam, is carried out between the cleaning program step and the drying step. For example, for this purpose, steam can be introduced into the rinsing chamber through one or more nozzles, after which this steam sanitizes or disinfects the object to be cleaned for a defined action time.

Again, as also in the cases described hereinbefore, the cleaning appliance may in turn, in the case of the commode rinser, be configured in such a way that a blower of the microwave drying device is used for assisting the drying. In this case, the commode rinser can for example have an outflow with a siphon bend, the commode rinser further having an outgoing air line which merges from the rinsing chamber with the outflow while bypassing the siphon bend (or a water supply received in the siphon bend). The blower may be configured to displace humid air from the rinsing chamber (i.e. air of the air flow generated by the blower) into the outflow. In this way, a microwave drying step, in which moisture is discharged into the outflow, can be carried out, for example, following the steam sterilization step or steam disinfection step. The outgoing air line can have, in particular, a self-locking valve, preferably a check valve, to prevent contaminated air from returning from the outflow into the rinsing chamber and causing recontamination there of the object to be rinsed.

In addition to the above-described cleaning appliance in one of the illustrated embodiments, wherein the features may also be used in any desired possible combination, a method is also proposed. This method may include all or some of the method steps which have been described in part hereinbefore. The method serves to clean the object to be cleaned in a cleaning appliance, for example a cleaning appliance in one of the above-described embodiments. In this case, the object to be cleaned is cleaned in at least one cleaning zone of the cleaning appliance using a cleaning liquid. Furthermore, the object to be cleaned is at least partially dried by means of a microwave drying device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a continuous-flow dishwashing machine according to the invention;

FIG. 2 shows an exemplary embodiment of a single-chamber dishwashing machine according to the invention; and

FIG. 3 shows an exemplary embodiment of a commode rinser according to the invention.

### DETAILED DESCRIPTION

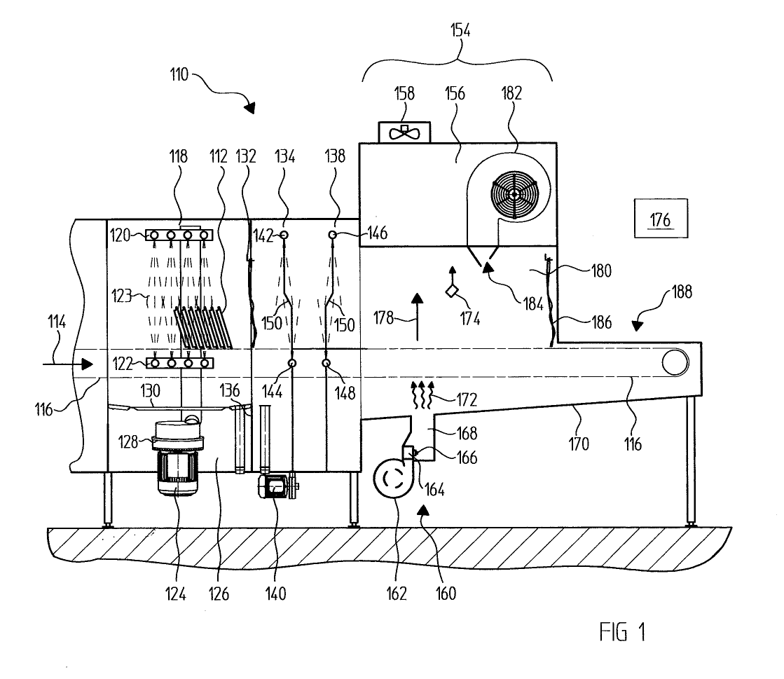

FIG. 1 is a schematic sectional side view of a first exemplary embodiment of a cleaning appliance. In this case, the cleaning appliance is configured as a continuous-flow dishwashing machine 110. In this continuous-flow dishwashing machine 110, objects 112 to be cleaned are transported in a direction of continuous flow 114 or direction of transportation through treatment zones or cleaning zones of the continuous-flow dishwashing machine 110. A conveying device 116, which is embodied in the illustration according to FIG. 1 as an endless transportation belt, transports the object 112 to be cleaned through the various cleaning zones of the continuous-flow dishwashing machine 110.

Viewed in the direction of transportation 114 of the object 112 to be cleaned, the object to be cleaned passes first through a rinsing zone 118. A first rinsing system 120 and also a second rinsing system 122 are located within the rinsing zone 118. Cleaning fluid 123 issues from the rinsing system in the form of a jet. The first rinsing system 120 and the second rinsing system 122 are acted on with cleaning fluid via a first pump 124. The first pump 124 is accommodated within a rinsing zone tank 126 which is associated with the rinsing zone 118. A pump housing 128 is located in the upper region of the first pump 124. The rinsing zone tank 126 is covered by means of a tank cover screen 130. The rinsing zone tank 126, which is associated with the rinsing zone 118, contains a heated or unheated water supply.

The rinsing zone 118 is separated by means of a separating curtain 132 from the pump clear-rinsing zone 134 which adjoins—viewed in the direction of transportation 114 of the object 112 to be cleaned—the rinsing zone. The rinsing zone tank 126 is separated via a separating wall 136 from the tank which is located below the pump clear-rinsing zone 134 or a fresh water clear-rinsing zone 138 adjoining the pump clear-rinsing zone 134.

In the illustration according to FIG. 1, the object 112 to be cleaned enters, as it leaves the rinsing zone 118, the pump clear-rinsing zone 134 after passing through the separating curtain 132. The pump clear-rinsing zone 134 is fed via a second pump 140. The cleaning fluid 123, which issues in the pump clear-rinsing zone 134 from a first spray tube 142 and a second spray tube 144, wets the object 112 to be cleaned from the upper side and the underside. The spray tubes 142, 144, which are arranged in the pump clear-rinsing zone 134, are received on a curved tube, so that an offset of the first spray tube 142 is attained compared to the second spray tube 144 of the pump clear-rinsing zone 134.

The same applies to the fresh water clear-rinsing zone 138 which may be connected downstream of the pump clear-rinsing zone 134. The fresh water clear-rinsing zone 138 comprises an upper spray tube 146 and a lower spray tube 148. The two spray tubes 146, 148 are, in accordance with the course 150 of the spray tube, likewise arranged offset relative to each other, viewed in the direction of transportation 114 of the object 112 to be cleaned. The volume of the fresh water issuing from the upper spray tube 146 and the lower spray tube 148 wets the cleaning object 112, from the upper side thereof and the underside thereof, with a jet of fresh water 152.

A drying zone 154 is arranged downstream of the fresh water clear-rinsing zone 138. This drying zone 154 may for example be separated from the fresh water clear-rinsing zone 138 by a further curtain (not shown in FIG. 1).

In the exemplary embodiment which is illustrated in FIG. 1 and does not limit the scope of the invention, the drying zone 154 is divided in two. In a first region, a heat recovery device 156 is arranged in the drying zone 154. This heat recovery device 156 comprises an outgoing air blower 158 by means of which outgoing air is drawn out of the continuous-flow dishwashing machine 110. For example, the heat recovery device 156 can comprise a heat exchanger via which heat exchanger liquid is heated in order subsequently to be used, for example, in the rinsing zone tank 126. In this way, the discharged heat is at least partially reused, so that the amount of energy required for heating the rinsing zone tank 126 may be reduced. Furthermore, the heat recovery device 156 can also comprise a condensation precipitation device (not shown) in order to at least partially condense humid air.

Furthermore, a microwave drying device 160 is provided in the region of the heat recovery device 156. The exemplary embodiment illustrated in FIG. 1 shows in this case just one microwave drying device 160 of this type, wherein a plurality of devices of this type may of course also be provided, for example in order to act on the object 112 to be cleaned with microwaves from a plurality of sides.

The microwave drying device 160 comprises in this exemplary embodiment a blower 162 which cools a magnetron 164. The dimensions of the blower 162 are indicated merely schematically in FIG. 1.

The magnetron 164 comprises an anode 166 as the transmitter antenna. This anode 166 protrudes into a waveguide 168 into which microwave radiation 172, which is generated by the magnetron 164, is coupled. The waveguide 168 is dimensioned accordingly and may have for example a square or rectangular cross section.

The waveguide 168 has in the exemplary embodiment in FIG. 1 a substantially upwardly directed, perpendicular course and is coupled to a housing bottom 170 of the continuous-flow dishwashing machine 110 below the conveying device 116.

The microwave drying device 116 and the magnetron 164 are configured to generate microwave radiation 172 and to apply microwave radiation via the waveguide 168 to the object 112 to be cleaned when the object to be cleaned is located in the region in which the waveguide 168 merges with the drying zone 154. Sensors may be provided that detect whether objects 112 to be cleaned are located above this merging, so that preferably microwave radiation 172 is generated merely in this case. Alternatively or additionally, the anode 166 may also be used as a detector in order to detect whether objects 112 to be cleaned are present, such as is for example also proposed in EP 1327844 A2. In this way, energy may be saved by preventing unnecessary microwave irradiation. The microwave radiation 172 may be configured in accordance with one of the above-described exemplary embodiments, for example having a frequency in the range of 2.5 GHz. Variation of the irradiated frequency bands of the microwave radiation 172 over time is also conceivable. Furthermore, the conveying device 116 and also if appropriate a basket or a different receiving device for receiving the object 112 to be cleaned will be configured so as to be substantially transparent to the irradiated microwave radiation 172, for example by way of appropriate configuration of the materials.

In the exemplary embodiment illustrated in FIG. 1, the point at which the waveguide 168 merges with the interior of the drying zone 154 is substantially open. However, in addition, flaps, valves, curves, microwave-transparent roofs or other configurations may be provided which, while allowing the object 112 to be cleaned to be acted on with microwave radiation 172, prevent water or a different cleaning liquid dripping from the object 112 to be cleaned from reaching the magnetron 164 through the waveguide 168 and damaging the magnetron.

A temperature sensor 174 can be provided in the region of the point at which the waveguide 168 merges with the drying zone 154 for monitoring a temperature of the object 112 to be cleaned. The signals from this temperature sensor 174 can be transmitted for example to a central controller 176 which is indicated merely schematically in FIG. 1 and which can, for example, activate the magnetron 164.

The blower 162 of the microwave drying device 160 generates an air flow 168 which is directed upward in FIG. 1. As the magnetron 164 generates heat which is absorbed by the air flow 178, this heated air flow 178 additionally assists the drying effect of the object 112 to be cleaned. The heated air flow 178 rises up to the heat recovery device 168, where the heat of this air flow 178 is partially recovered.

As a further, optional part of the drying zone 154, a blower zone 180 adjoins the region in which the heat recovery device 156 and the microwave drying device 160 are received. A drying blower 182 is received in this blower zone 180. Heated air issuing from the drying blower 182 is blown via outlet nozzles 184 onto the upper side of the object 112 to be cleaned. However, owing to the microwave radiation 172 and the drying effect of the microwave drying device 160, the drying blower 182 may in the ideal case be dispensed with altogether, or the dimensions of this drying blower 182 may be greatly reduced. A considerable amount of expended energy may be saved in this way.

The drying zone 154 is screened off from a run-out section 188 by a further separating curtain 186. In the region of the run-out section 188 of the continuous-flow dishwashing machine 110 according to the illustration in FIG. 1, the dried and partially cooled object 112, which has now been cleaned, can be removed from the conveying device 116 which is embodied as a transportation belt.

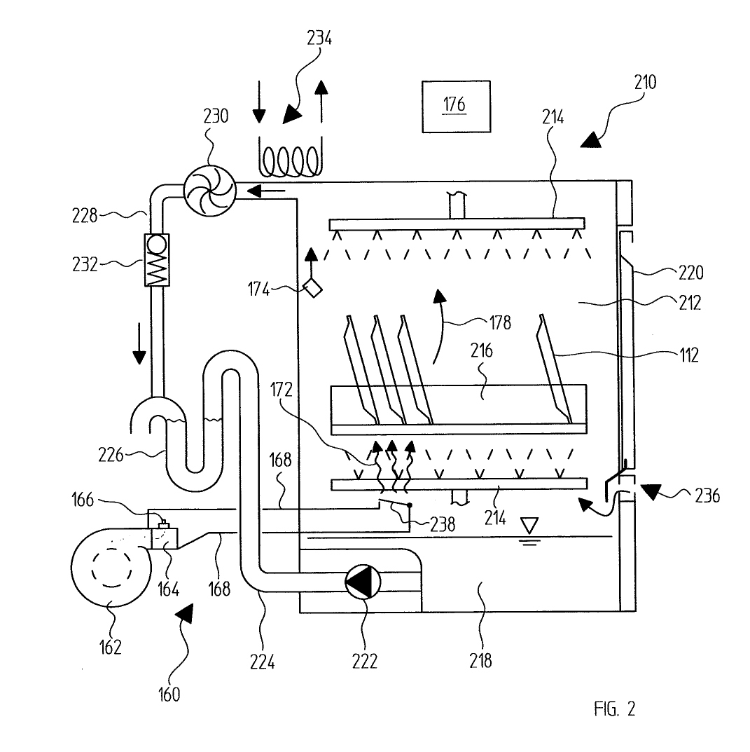

FIG. 2 shows a second exemplary embodiment of a cleaning appliance for cleaning objects 112 to be cleaned. In this case, the cleaning appliance is a single-chamber dishwashing machine 210. The single-chamber dishwashing machine 210 comprises a rinsing chamber 212 with a spray nozzle system 214, which is received therein, and also with corresponding devices (not shown in FIG. 2) for conveying cleaning liquid to this spray nozzle system 214. In this way, the object 112 to be cleaned, which is received in a corresponding basket 216, can be acted on with rinsing liquid from a tank 218 in the bottom region of the rinsing chamber 212.

The rinsing chamber 212 can be accessed through a front flap 220 and can be loaded with objects 112 to be cleaned. Waste water from the tank 218 can be pumped away into a run-out 224 via a run-out pump 222. The run-out 224 comprises a siphon bend 226 with a water supply received therein as an odor trap. The single-chamber dishwashing machine 210 has a hot air outlet 228 which connects the interior of the rinsing chamber 212 to the run-out 224 while bypassing the siphon bend 226. A blower 230 and a check valve 232 are received in the hot air outlet 228. In addition, the hot air outlet 228 has a heat recovery device in the form of a heat exchange 234 which is indicated merely symbolically in FIG. 2. Heat can be at least partially withdrawn from the hot outgoing air, which is suction-extracted from the rinsing chamber 212, by means of this heat exchange 234. The heat exchanger liquid can subsequently be supplied to the tank 218, for example, thus allowing energy to be saved. An air inlet 236 in the form of a gap, through which a pressure compensation can be carried out in the rinsing chamber 212, is provided below the front flap 220 of the rinsing chamber 212. This air inlet 236 is, such as for example also the hot air outlet 228, an optional component. The single-chamber dishwashing machine according to the invention could also be embodied without these components.

Furthermore, the single-chamber dishwashing machine 210 according to the exemplary embodiment in FIG. 2 has a microwave drying device 160. This microwave drying device 160 comprises, again, as also in the exemplary embodiment in FIG. 1, a blower 162, a microwave source (in this case, again, in the form of a magnetron 164 with a magnetron anode 166 and a waveguide 168 leading into the interior of the rinsing chamber 212). Again, the microwave drying device 160 is illustrated in FIG. 2 merely schematically and can, for example, also comprise a plurality of microwave sources and a plurality of waveguides 168.

In the exemplary embodiment illustrated in FIG. 2 of the single-chamber dishwashing machine 210, the microwave drying device 160 is configured in such a way as to generate via its blower 162 an upwardly directed air flow 178. This air flow 178 assists the drying of the object 112 to be cleaned after cleaning of the object 112 to be cleaned has been carried out using cleaning liquid. The air flow can subsequently be suction-extracted into the run-out 224 via the blower 230. Owing to the admission of air through the blower 162 of the microwave drying device 160, the air inlet gap 236 may optionally be dispensed with if the two blowers 162 and 230 are accordingly adapted to each other.

The waveguide 168 of the microwave drying device 160 has an upwardly directed curvature at its end protruding into the rinsing chamber 212. Preferably, the waveguide 168 is configured so as to prevent cleaning liquid from passing to the magnetron 164 through the waveguide 168. For this purpose, the waveguide 168 can have, for example in the region of the curvature, corresponding slots or other openings as the run-out. Additionally or alternatively, in this as also in the other exemplary embodiments, the waveguide 168 can have a valve at its end or in its interior. This valve is illustrated symbolically in FIG. 2 in the form of a flap 238. The air flow generated by the blower 162 may be sufficient to open this flap 238, so that microwave radiation 172 can reach unimpeded the object 112 to be cleaned. Other forms of liquid repulsion (for example water-repellent surfaces which are transparent to microwaves) are conceivable, as described hereinbefore.

Again, the single-chamber dishwashing machine 210 has in the exemplary embodiment illustrated in FIG. 2 a temperature sensor 174 inside the rinsing chamber 212, wherein the temperature sensor can be used to monitor the microwave drying. A controller 176, which can be acted on for example with signals from the temperature sensor 174 and which can control the program sequence, is, again, provided.

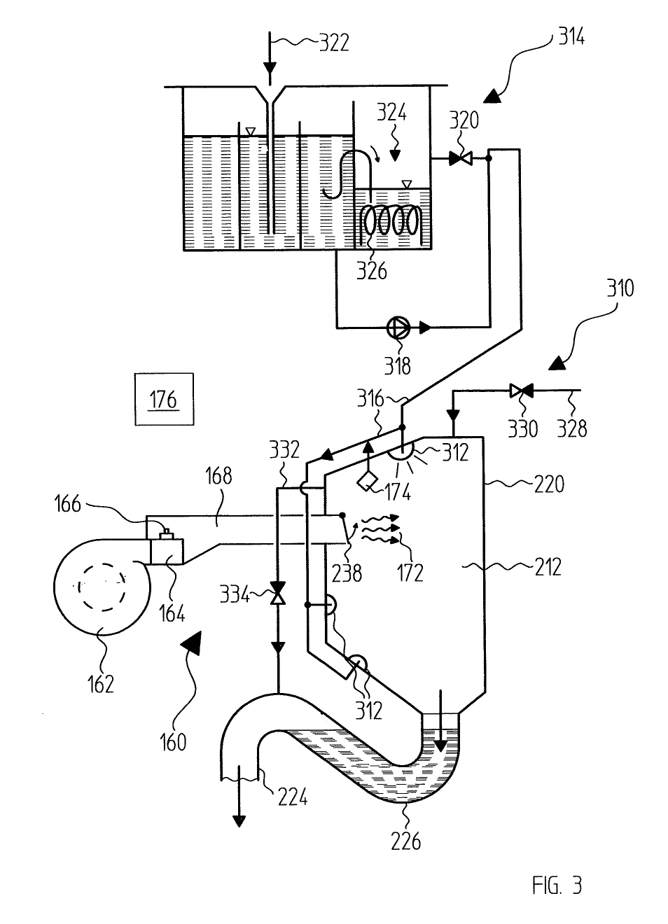

FIG. 3 shows a third exemplary embodiment of a cleaning appliance according to the present invention. In this exemplary embodiment, the cleaning appliance comprises not a dishwashing machine but rather a commode rinser 310. For details of a possible configuration of this commode rinser 310, reference may be made, as an example, to the configuration described in DE 10348344 A1.

The commode rinser 310 comprises a rinsing chamber 212 with a front flap 220. Objects 112 to be cleaned can be received in the rinsing chamber 212 by means of a mount (the mount and object to be cleaned are not shown in FIG. 3). For example, the commode rinser 310 may be configured in such a way that the object to be rinsed is automatically emptied on closing of the front flap 220. In this way, liquid or solid waste from the object to be rinsed can be emptied into a run-out 224 of the commode rinser 310. This ensures that the commode rinser 310 is suitable for cleaning objects 112 which are to be cleaned and have an accumulation of relatively large amounts of liquid. As a result, the commode rinser 310 differs, for example, from autoclaves which are used for sterilizing medical instruments. However, the microwave drying according to the invention may also be used in an autoclave as a cleaning appliance.

In the rinsing chamber 212, the object to be rinsed can be acted on with cleaning liquid from a water/steam unit 314 via a system of nozzles 312. This water/steam unit 314 is connected to the nozzles 312 via a pipeline system 316 (wherein the nozzles 312 may be simple openings and also/or else more complexly configured spray nozzles). Furthermore, a pump 318 and also a check valve 320 are received in the pipeline system 316. Fresh water is fed to the water/steam unit 314 via a fresh water run-in 322. Furthermore, the water/steam unit 314 comprises a steam generator 324 with a heater 326, so that the object to be cleaned can be acted on with steam inside the rinsing chamber 212 via the pipeline system 316 and the nozzles 312. A conventional cleaning process may thus provide, for example after an emptying of the object 112 to be cleaned, a cleaning using cleaning liquid (for example hot and/or cold water, if appropriate in each case with additives) which follows a steam disinfection step. For details of this process, reference may for example be made, again, to the above-described DE 10348344 A1.

Furthermore, the commode rinser 310 according to the exemplary embodiment illustrated in FIG. 3 comprises a feed line 328 which has a check valve 330 and merges with the rinsing chamber 212. The feed line 328 can be connected, for example, to a fresh air blower (not shown) and can be used to displace, after a disinfection step, steam into the run-out 224 via an outgoing air line 332 while bypassing the siphon bend 226. A self-locking valve, in the form of a check valve 334, is, again, received in the outgoing air line 232. In this way, after carrying out the steam disinfection step, the object to be cleaned can be cooled and already partially dried by incoming air, and the steam can be at least partially displaced from the rinsing chamber 212 into the run-out 224, so that the working environment is charged only slightly on opening of the front flap 220. It should however be noted that the feed line 328 and the outgoing air line 332 are each optional components and that the commode rinser 310 could also in each case be embodied without these components or with in each case only one of these components.

Furthermore, the commode rinser 310 according to the invention in accordance with the exemplary embodiment illustrated in FIG. 3 comprises, again, a microwave drying device 160. This microwave drying device 160 is, for example, configured in a similar manner to the microwave drying devices 160 according to the aforementioned exemplary embodiments, so that reference may be made to the foregoing descriptions. Again, the microwave drying device 160 comprises a waveguide 168 which merges with the rinsing chamber 212 and via which the object 112 to be cleaned can be acted on with microwave radiation 172. In the exemplary embodiment illustrated in FIG. 3, as in the example in FIG. 2, the microwave drying device 160 preferably also has, as the point at which the waveguide 168 merges with the rinsing chamber 212, a self-locking valve which may be configured for example, again, in the form of a flap 238. Not only does this flap 238 prevent moisture from infiltrating the waveguide 168; it can also cause tightness of the rinsing chamber 212 during displacement of the steam from the rinsing chamber 212. Thus, the flap 238 can be closed, during injecting of fresh air via the feed line 328 (for example via a blower (not shown)), as a result of a slight excess pressure in the rinsing chamber 212, thus allowing humid outgoing air and steam to be displaced into the run-out 224 via the outgoing air line 332, the flap 238 at least substantially preventing this humid air and this steam from being displaced up to the microwave source or the magnetron 164. The check valve 334 prevents recontamination of the interior of the rinsing chamber 212 and the object 112 to be rinsed that is received therein. Subsequently, for example following the described steam displacement step, the microwave drying device 160 can be started (for example, again, via a controller 176 which controls the program sequence accordingly), so that the object 112 to be rinsed is acted on with microwave radiation 172. Again, the blower 162 of the microwave drying device 160 can in this case generate inside the rinsing chamber 212 an air flow which assists the drying of the object 112 to be cleaned. Excess pressure, which is generated by the blower 162 of the microwave drying device 160, can be discharged into the run-out 224 via the outgoing air line 332.

It should be noted that this configuration of the commode rinser 310 in FIG. 3 is to be understood as being merely exemplary and that further configurations are possible. A program sequence could for example provide, in addition to the above-described program sequence, the following steps: emptying the object to be rinsed into the run-out 224, one or more cleaning steps using cleaning liquid (for example hot and/or cold water, if appropriate in each case with additives), a steam disinfection step (optional), a step for displacing steam by fresh air (optional), and one or more microwave drying steps. Individual program steps may also be carried out repeatedly, and the illustrated order is preferred, but not compulsory. A further advantage of the microwave drying consists in the fact that the microwave drying can also assist, both in the exemplary embodiment illustrated in FIG. 3 and in other exemplary embodiments of a cleaning appliance, a disinfection process, for example in that the microwave radiation 172 is selected in such a way (for example by way of appropriate selection of a frequency range) that the microwave radiation has a germicidal effect. The microwave drying can, again, be monitored via a temperature sensor 174, which is, again, indicated symbolically in FIG. 3, and be controlled for example by the controller 176.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning appliance for cleaning objects to be cleaned, wherein the cleaning appliance has at least one cleaning zone for cleaning the object to be cleaned using a cleaning liquid, the cleaning appliance comprising a microwave drying device for at least partially drying the object to be cleaned, the microwave drying device being configured to emit microwaves in a frequency band, the microwave drying device being furthermore configured to vary the frequency band over time, so that the frequency band covers successively different frequency ranges.

2. The cleaning appliance as claimed in claim 1, wherein the microwave drying device has at least one waveguide for orienting microwaves onto the object to be cleaned, wherein the waveguide has a closable opening, in particular an opening flap, inside the cleaning zone.

3. The cleaning appliance as claimed in claim 1, wherein the microwave drying device is configured to apply hot air to the object to be cleaned.

4. The cleaning appliance as claimed in claim 1, wherein the microwave drying device is configured to act on the object to be cleaned with microwaves having at least two frequencies.

5. The cleaning appliance as claimed in claim 1, wherein the microwave drying device is configured to emit microwaves having at least one frequency, wherein the frequency is at least one of: a frequency which is at least partially absorbed by the object to be cleaned and a frequency which is at least partially absorbed by cleaning liquid clinging to the object to be cleaned.

6. The cleaning appliance as claimed in claim 1, wherein the cleaning appliance has at least one temperature sensor for detecting the temperature of the object to be cleaned.

7. The cleaning appliance as claimed in claim 1, wherein the microwave drying device comprises at least one blower, the blower being configured to assist drying of the object to be cleaned by an air flow.

8. The cleaning appliance as claimed in claim 1, wherein the cleaning appliance has a heat recovery device and/or a steam precipitation device.

9. The cleaning appliance as claimed in claim 1, wherein the cleaning appliance comprises a continuous-flow dishwashing machine, wherein the cleaning zone comprises at least one clear-rinsing zone, the microwave drying device being arranged after the clear-rinsing zone in a direction of continuous flow.

10. The cleaning appliance as claimed in claim 1, wherein the cleaning appliance comprises a single-chamber dishwashing machine, in particular an industrial single-chamber dishwashing machine, the cleaning zone comprising a rinsing chamber.

11. The cleaning appliance as claimed in claim 10, wherein the single-chamber dishwashing machine is configured to carry out a cleaning program, the cleaning program having at least one cleaning program step, the object to be cleaned being cleaned using the cleaning liquid in the at least one cleaning program step, the cleaning program further having at least one drying step which follows the cleaning program step in time, the object to be cleaned being at least partially dried using the microwave drying device in the drying step.

12. The cleaning appliance as claimed in claim 1, wherein the cleaning appliance has a commode rinser for cleaning medical equipment and/or care equipment, the cleaning zone comprising a rinsing chamber, the commode rinser being configured to act on objects to be cleaned in the rinsing chamber with the cleaning liquid and the microwave drying device being configured to at least partially dry the object to be cleaned in the rinsing chamber.

13. The cleaning appliance as claimed in claim 12, wherein the commode rinser further has a steam generating device, the commode rinser being configured to sanitize the object to be cleaned by means of steam.

14. The cleaning appliance as claimed in claim 12, wherein the microwave drying device has a blower, the commode rinser having a run-out with a siphon bend, the commode rinser further having an outgoing air line which merges from the rinsing chamber with the run-out while bypassing the siphon bend, the blower being configured to displace humid air from the rinsing chamber into the run-out.

15. A method for cleaning objects to be cleaned in a cleaning appliance, wherein the object to be cleaned is cleaned in at least one cleaning zone of the cleaning appliance using a cleaning liquid, the object to be cleaned being furthermore at least partially dried by means of a microwave drying device, microwaves in a frequency band being emitted by means of the microwave drying device, the frequency band being varied over time, so that the frequency band covers successively different frequency ranges.
